(19) United States
(12) Patent Application Publication
(10) Pub. No.: US 2020/0016622 A1
(43) Pub. Date: Jan. 16, 2020

(54) TELESCOPIC LANCE

(71) Applicant: SWANTECH AS, Kleppestø (NO)

(72) Inventor: Morten TORLEI, Bones (NO)

(73) Assignee: SwanTech AS, Kleppestø (NO)

(21) Appl. No.: 16/335,793

(22) PCT Filed: Sep. 25, 2017
(86) PCT No.: PCT/NO2017/050243

§ 371 Date: Mar. 22, 2019

(30) Foreign Application Priority Data
Sep. 25, 2016 (NO) 20161535

(51) Int. Cl. B05B 15/628; B05B 15/652

(52) U.S. Cl. CPC B05B 15/628; B05B 15/652

(57) ABSTRACT

A bendable telescopic lance device was disclosed. It is comprised of a flexible inner tube (1), a bendable telescopic element (2), and an outer pipe (4). These components are arranged such that sliding the outer pipe (4) with respect to the inner pipe (1) causes the telescope end element to either telescopically expand or retract. Bends in the components of the telescopic end element allow for the spraying angle to be changed. Associated methods for the adjustment of the spraying angle by adjusting relative the position of the inner tube (1) with respect to the outer pipe (4) were also disclosed.

### THE FIELD OF THE INVENTION

The present invention relates to a bendable telescopic lance.

The present invention also relates to a method for adjusting the spraying direction of a material of a bendable telescopic lance.

The present invention relates to a lance with a telescopic end and, more particularly, for the adjustment of the spray angle at the end of the lance during operation.

### INTRODUCTION

The spraying of material under pressure through a lance or handle of some kind and onto the desired area is a well known process. Examples include sand blasting, paining, spraying pesticides, air pressure and rubberizing layers. One of the most common examples is water used in power sprayers. These are a commonly found in both industry and residential use. Water enters the power sprayer from a hose; where it is pressurized. The user directs the water stream in the desired direction and intensity using a trigger on the lance.

A user can have difficulties when they want to spray at an angle that is not along the body of the lance. This difficulty is magnified in the case where there is not a lot of space to maneuver the lance. For example, to spray the underside of a car with a power sprayer may require the user to lie on the ground. To clean a part of the underside of the car that is close to the user (e.g. behind the wheel wells) will be close to impossible because of the tight space in between the car and the ground. Another example of this is when someone wants to clean their gutters. Without the ability to change the direction of the water spray with respect to the lance, the user must climb a ladder and spray down from above. Further, it can be difficult to pressure wash a wall before painting it from a scaffold in a safe manner. The scaffold is usually very close to the wall and the lance trigger is often held behind the user during operation.

Changing of the spraying angle is usually done by attaching a stiff arm to the end of the outlet hose. This can slide over the body of the sprayer lance. By moving the stiff arm down, the end of the outlet hose is moved downwards changing the angle. Another solution has been to construct the end of the sprayer such that it can be physically bent into a new position.

The purpose of the present invention is to provide an improved bendable lance. The present invention presents a novel solution that uses a telescopic end element that has curved components. During operation, the user can adjust the length of the telescopic element which will change the angle between the main body of the lance and the spraying direction.

### SHORT SUMMARY OF THE INVENTION

In a first aspect, the present invention relates to a bendable telescopic lance for spraying of a material, comprising:
a flexible inner tube, a bendable telescopic element with an inlet side and an outlet, and an outer pipe;
   wherein:
the flexible inner tube is located inside, and connected in a longitudinally mutually slidable manner to, the outer pipe;
the outer pipe is connected to the inlet side of the bendable and the inner tube is connected to the outlet side of the bendable telescopic element; and
where the relative position of the inner tube and the outer pipe determines the spatial position of the end of the inner tube.

In an embodiment comprises the outlet side of the bendable telescopic element an end outlet; and the inner tube is connected to the end outlet.

In an embodiment comprises the outlet side of bendable telescopic element a base connector; and the outer pipe is connected to the base connector.

In an embodiment comprises the bendable telescopic element a telescope base and a telescope end, arranged in a telescopic manner.

In an embodiment are the bendable telescopic element of one or more intermediate elements arranged in a telescopic manner and located between the telescope base and the telescope end.

In an embodiment are there between 1 and 8 intermediate elements, preferably between 2 and 5, and more preferably 3 or 4.

In an embodiment are the components of the telescope base and telescope end and optionally the intermediate elements, of the bendable telescopic element slidably connected to each other using a tab and groove system, wherein the tab of one component engage within the groove of the adjacent component.

In an embodiment comprises the bendable telescopic lance a handle with an inside and an outside; wherein the inside of the handle is fixedly attached to the outside of the outer pipe.

In an embodiment comprises the bendable telescopic lance a handle with an inside and an outside; wherein the inside of the handle is fixedly attached to the outside of the outer pipe.

In an embodiment is the bendable telescopic lance used with a high pressure sprayer.

In preferred embodiments is the telescopic lance used to spray material chosen from the group consisting of: particulate matter, liquids, or gases; preferably the material is selected from: sand, paint, aqueous solutions, water, air pressure and steam, most preferably the material is water, steam, or air.

In a preferred embodiment comprises the inner tube comprises one or more flexible tube end sections and one and more tube body sections; wherein
the flexible tube sections are connected to form a continuous tube;
the tube body sections are connected to form a continuous tube; and
where the outlet end of the flexible tube section is connected to the end outlet.

A second aspect of the present invention relates to a method for adjusting the spraying direction of a material of a bendable telescopic lance comprising:
a flexible inner tube, a bendable telescopic element with an inlet side and an outlet, and an outer pipe;
wherein:
the flexible inner tube is located inside, and connected in a longitudinally mutually slidable manner to, the outer pipe;
the outer pipe is connected to the inlet side of the bendable telescopic element and the inner tube is connected to the outlet side of the bendable telescopic element;
wherein the method comprises the steps of:
moving the outer pipe with respect to the inner tube;
forcing the bendable telescopic end element to change the relative position of the inner tube with regard to the outer pipe; and thereby
changing the spraying direction on the outlet side of the bendable telescopic end element.

In embodiments of this aspect is the material chosen from the group consisting of: particulate matter, liquids, or gases; preferably the material is selected from: sand, paint, aqueous solutions, water, air pressure and steam, most preferably the material is water, steam, or air.

### BRIEF DESCRIPTION OF THE FIGURES

FIG. 1 discloses a perspective view of an embodiment of the present invention.

FIG. 2 discloses a cross section of an embodiment of the present invention.

FIGS. 3A and 3B disclose top view of two different configurations of the present invention

FIG. 4A discloses an exploded view of an embodiment of the invention.

FIG. 4B discloses an alternate embodiment of the inner tube of the invention.

FIGS. 5A and 5B discloses the groove and tab system between two components.

FIG. 6 discloses a perspective view of the preferred embodiment of the bendable telescopic element.

### DETAILED DESCRIPTION OF THE INVENTION

Using the attached drawings, the technical contents, and detailed descriptions, the present invention is described. Alternate embodiments will also be presented. The present invention allows a user to adjust the angle that materials are sprayed from a hose or tube by movement of a handle toward or away from the end of the device.

It is accomplished due to the response of a telescopic part which contains a flexible tube and collapses or expands in a telescopic manner depending on the force applied to the outer pipe of the system. This is described in further detail below. Note that direction toward where the material enters the system (i.e. direction that the material is supplied from) will be referred to as the inlet side and where the material exits will be referred to as the outlet side.

The present invention could be used to deliver a wide range of materials from the outlet such as sand, dirt, soil, paint, chemicals, epoxy, rubber, etc. The invention is directed primarily toward water, air, or steam as the material used.

The present invention can be used in both low pressure and high pressure systems. A typical low pressure system would be using a traditional garden house. A higher pressure system would be a pressure washer for home or commercial use. Another example of a higher pressure system would be for sand blasting. The invention is directed toward use with a power washer.

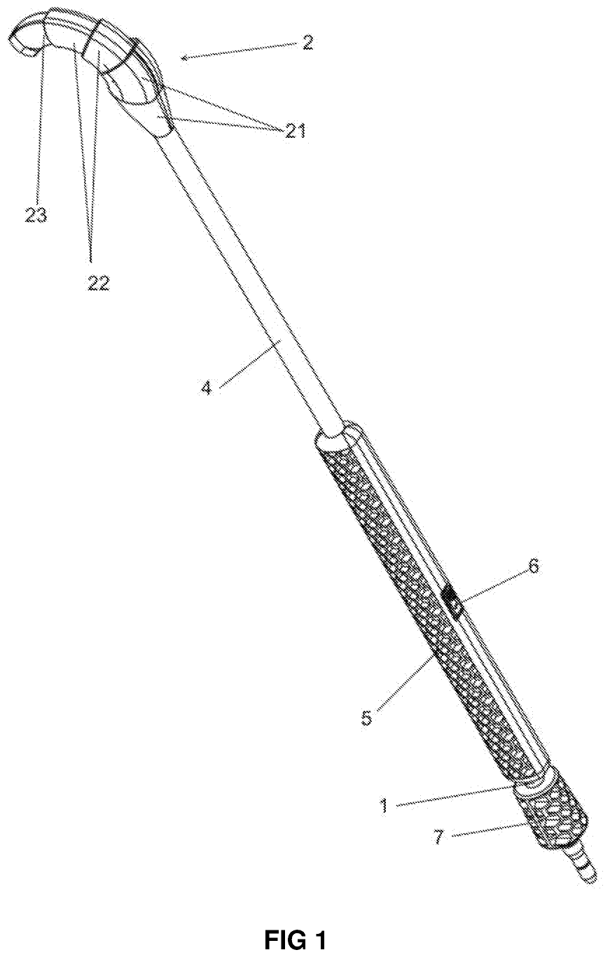

Reference is made to FIG. 1. This figure discloses a perspective view of an embodiment of the present invention.

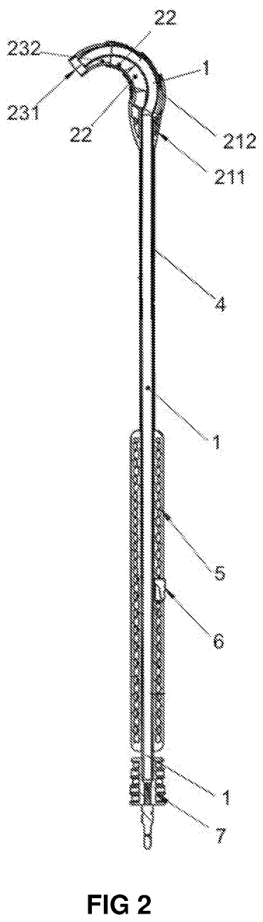

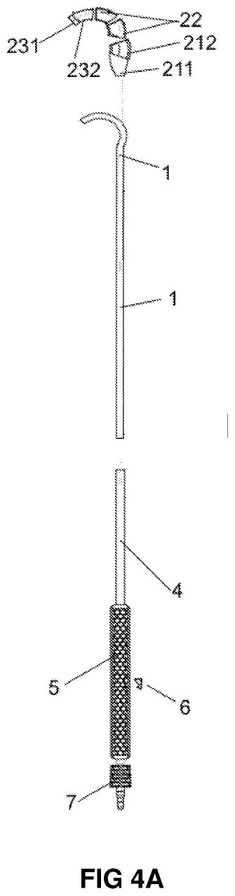

A bendable telescopic element 2 is made up of a telescope base 21, two intermediate elements 22, and a telescope end 23. The bendable telescopic element 2 is connected to the outer pipe 4. Note that the telescope base 21 can be made up of two parts that will be described in more detail in the discussion of FIGS. 2 and 4A. An inner tube 1 is located inside the outer pipe 4 and they can slide with respect to each other. A handle 5 is fixedly attached to the outer pipe 4. A lance connector 7 connects the present invention to a supply of material (e.g. water, sand, paint, etc.). A locking mechanism holds locks between the inner tube 1 and the outer pipe 4 in place. This lock is released through the use of a release button 6. The inner tube 1 passes from the lance connector 7 on the inlet side, through the outer pipe 4, and through the bendable telescopic element 2 on the outlet side.

The lock release button 6 is shown as a single button located in the middle of the handle 5. This is simply an example. The locking mechanism could be placed along most of the length of the invention, depending on the needs of the user. Practically, this will normally be located someplace upon the handle. The location of the release button, and the type of release button, is also not limited. These would be determined by one skilled in the art if needed.

It is important to note that the locking mechanism need not be present at all. In such a case, force from the user (muscle power or assisted) would keep the bendable telescopic element 2 from changing into an undesired spray direction. In such a way, the locking mechanism is not necessary for operation of the present invention, but can be used whenever the uses desired the telescopic element 2 to be locked in place.

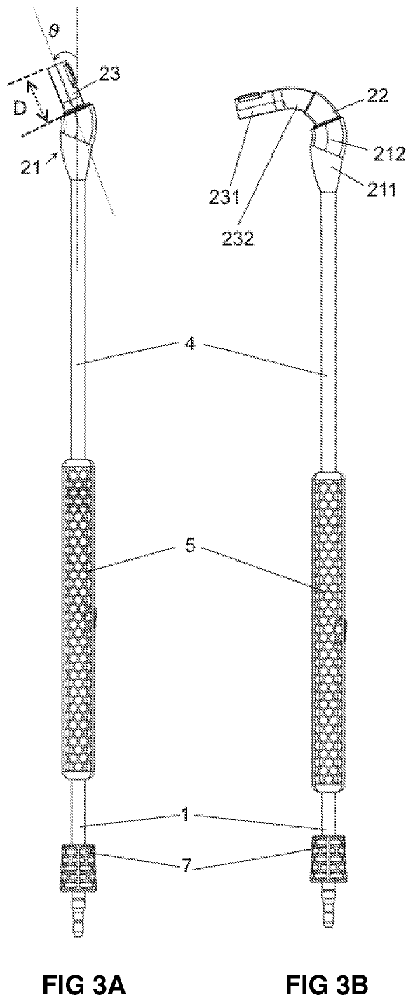

The entire bendable telescopic element 2 is designed to collapse together in a telescopic way. By that it is meant that the telescope base 23 fits inside the outlet-most intermediate element 22, which in turn fits inside the inlet-most intermediate element 22, which fits inside the telescope base 21. In such a way, most of the bendable telescopic element 2 could be designed to fit inside the telescope base 21 when in the fully retracted position. This topic will be returned to when discussing FIGS. 3A and 3B.

Note that even though a handle is shown in FIG. 1, this is not needed. It only makes it easier and more convenient for the sliding of the outer pipe 4 with respect to the inner tube 1.

Also, all of the figures will show the bendable telescopic element 2 with two intermediate elements 22, but these can be removed and the telescope base 21 directly connected to the telescope end 23. This could be an advantage in the case where fewer inner tube outlet positions were desired. The radius of curvature of the bendable telescopic element 2 can be chosen by one skilled in the art. Additionally, the curvature of each individual component of the bendable telescopic element 2 can be chosen to result in this desired radius. If more intermediate positions are required, then more intermediate elements 22 can be used. Conversely fewer intermediate elements 22 will result in fewer intermediate positions for the system.

In an embodiment of the invention, there are between 1 and 8 intermediate elements 22, preferably between 2 and 5, and more preferably 3 or 4.

Each component need not have the same radius of curvature and one or more of the components could be straight. However, at least one of the components of the bendable telescopic element 2 (telescope base 21, telescope end 23, and/or intermediate elements 22) must have a curve in it that brings the telescope end 23 away from the longitudinal axis of the outer pipe 4. It is obvious to one skilled in the art that the components of the bendable telescopic element 2 must be arranged such that they do not come apart when it is telescopically expanded.

The locking mechanism type and strength will be determined by the exact configuration of the outer pipe 4, inner tube 1, and handle 5 (if present). It will also be determined by the demands of the application of the invention. Under many operating conditions, and internal configurations, a locking mechanism may not.

A telescopic object is one in which one or more of its components can slide into each other, such that the length can be varied from some minimum length to a maximum length. In many applications it is desirable to have the minimum length possible when in a collapsed position. In that case, the components will be of successively smaller radius (in the case of circular cross section). In such a manner all of the components will almost fit entirely into a single component. This preferred embodiment is shown in FIG. 1 as the components grow smaller from the telescope base 21 to the telescope end 23.

While this arrangement of a telescopic object is the preferred one, this is not a requirement. In some cases, such as reinforcement of a joint, it could be desirable that a component not entirely fit within an adjacent component. For similar reasons, it could be desirable that the component is inside or outside of both components adjacent to it.

Reference is made to FIG. 2. This discloses a cross section of an embodiment of the present invention. The reference numbers and configuration are the same as shown in FIG. 1. A lance connector 7 is connected to the inner tube 1 on the inlet side. This inner tube passes through the outer tube 4, through the base connector 211, through the base housing 212, through each of the intermediate elements 22, through the end housing 232, and connects fixedly to the end outlet 231.

The telescope base 21 is comprised of the base connector 211 that is fixedly connected to the base housing 212. The telescope end 23 is comprised of the end house 232 that is fixedly connected to the end outlet 231.

The inner tube 1 is inside the outer pipe 4 and the outer pipe can slide with respect it. A handle 5 is fixedly attached to the outer pipe 4 to facilitate easier sliding of the outer pipe 4 with respect to the inner tube 1. A locking mechanism 6 keeps the position of the outer pipe 4 locked with respect to the inner tube 1. The inlet side of the system is that which is closest to where the material (e.g. water, paint, etc.) enters the system (lance connector 7 in FIG. 1) and the outlet side of the system is that closest to where the material exits the system (end outer 231 in FIG. 1).

Reference is made to FIGS. 3A and 3B. These disclose a top view of two different configurations of the present invention. As the outer pipe 4 (and handle 5) are moved over the inner tube 1, the travel distance D changes. D is defined as in FIG. 3A and is measured from the end of the telescope base 21 (i.e. the base housing 212) to the end of the telescope end 23 (i.e. the end outlet 231) along the surface of the bendable telescopic element 2.

The inner tube angle θ also changes. This is shown in FIG. 3A and is defined as the angle between the longitudinal axis of the outer pipe 4 and the direction that material will exit at the end outlet 231. Note that θ is measured starting from the longitudinal axis (as indicated by the arrow above the angle θ) and as such values greater than 180° are possible.

FIG. 3A shows the system in a retracted position. As the outer pipe 4 is slid over the inner pipe and toward the telescope end 23, the bendable telescopic element 2 begins to collapse together (as it is telescopic). Thus the travel distance D shortens and the inner tube angle θ approaches zero. Note that it could be adjusted such that the inner tube angle θ is zero in the retracted position.

FIG. 3B shows the system in a partially extended position. In this case, as the outer pipe 4 is pulled away from the telescope end 23, the bendable telescopic element 2 extends outwards. More specifically, the telescope end 23 extends out of the telescope base 21. Note that it follows a curved path due to the curved nature of one or more of the components (telescope base 21, telescope end 23, and optionally one or more intermediate elements 22). In other words the distance D lengthens and the inner tube angle θ increases.

Note that even through FIGS. 3A and 3B show one method of changing the inner tube angle θ, specifically moving the handle 5 toward the telescope end 23 to collapse the bendable telescopic element 2, the system could be designed to function in the opposite way through simple modification.

The movement of the outer pipe 4 with respect to the inner tube 1 could be accomplished using hand power, but the power could also be accomplished fully or partially through electrical or mechanical means.

Reference is made to FIG. 4A. This discloses an exploded view of an embodiment of the invention. The relationship between the inner tube 1, outer pipe 4, handle 5, locking mechanism 6, and the lance connector 7 is the same as shown in the previous figures. The bendable telescopic element 2 has been described as comprised of a telescope base 21, a telescope end 23, and optionally one or more intermediate elements 22. This figure further defines the telescope base 21 as comprised of a base connector 211 and a base housing 212. The base connector 211 is roughly straight and is the part of the telescope base 21 that is fixedly connected to the outer pipe 4. The base housing 212 will normally have a curved shape; but this is not a requirement. The telescope end 23 is comprised of a primarily bent end housing 232 and a primarily straight end outlet 232. The shapes of the telescope base 21 and the telescope end 23 are provided as an example.

As discussed previously, there is no requirement that part of these is either straight or curved. These are presented as a specific non-limiting example of the present invention. The exact shape of the components of the bendable telescopic element 2 can be adjusted by one skilled in the art without extensive experimentation to meet their needs.

Reference is made to FIG. 4B. This discloses a side view of an alternate embodiment of the inner tube 1 of the present invention. In this embodiment, the inner tube 1 is broken up into two parts. The first part is a flexible tube section 11. This section needs to be flexible enough to suitably bend inside the bendable telescopic element 2 during the expansion and retraction during operation of the invention. This flexible tube section 11 is connected to a tube body section 12. The tube body section will be rigid enough for the material and the pressures present. This can be determined by one skilled in the art.

While FIG. 4B shows the preferable embodiment where the inner tube 1 is made up of only two sections. It would be possible to be made up of multiple tube end sections 11 and tube body sections 12. These could be made of different materials with different properties.

The flexible tube section 11 need not connect to the tube body section 12 at the end, but could connect someone inside the tube body section. In an alternate embodiment, the flexible tube section 11 is located inside the entire length of the tube body section 12 and is not fixedly attached to it. In this way, it would be possible for the tube body section 12 to be as long as the outer pipe 4 with the flexible tube section 11 inside.

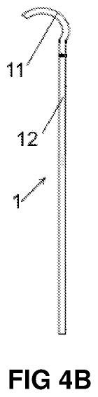

Reference is made to FIGS. 5A and 5B. These figures disclose the tab 9 and groove 10 system used in the bendable telescopic element 2 (one of the intermediate elements 22 is used as an example).

Each component of the bendable telescopic element 2 uses a tab 9 and groove 10 system to guide the telescope base 21, any number of intermediate elements 22, and the telescope end 23 through the telescoping process during changes of the position between the inner tube 1 and the outer pipe 4. These tabs 9 and grooves 10 also prevent the component from twisting during the use of the invention.

While a tab 9 and groove 10 system is the preferred embodiment, any number of alternate methods will present themselves to one skilled in the art. More than one tab 9 and groove 10 type system could be used. The pieces themselves could be shaped such that it is impossible for them to twist. Under some conditions, the twisting of the components is of no consequence. This will be determined by the requirements of the application of the invention.

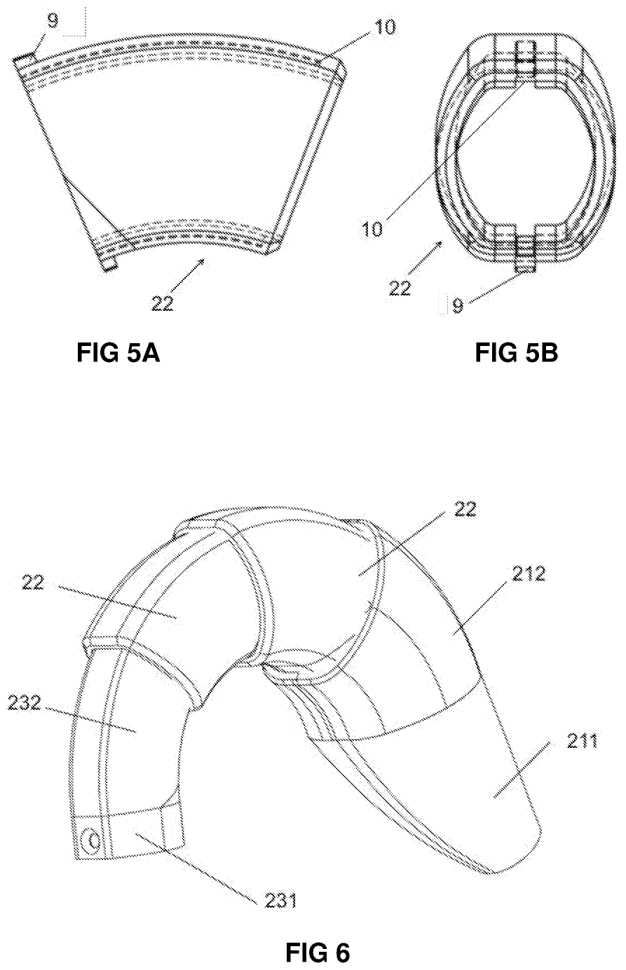

Reference is made to FIG. 6. This figure discloses a perspective view of the preferred embodiment of the bendable telescopic element 2 in the extended state. The meaning of the reference numbers is the same as has previously presented.

The angle that material is sprayed out of the present invention is adjusted by moving the inner tube 1 relative to the outer pipe 4. In this way, the bendable telescopic element 2 will change length. This will change the spraying angle from the outlet side of the bendable telescopic element 2 and thus the direction of the material spray.

1. A bendable telescopic lance for spraying of a material, comprising:
a flexible inner tube (1), a bendable telescopic element (2) with an inlet side and an outlet side, and an outer pipe (4); wherein
the flexible inner tube (1) is located inside, and connected in a longitudinally mutually slidable manner to, the outer pipe (4);
the outer pipe (4) is connected to the inlet side of the bendable telescopic element (2) and the inner tube (1) is connected to the outlet side of the bendable telescopic element (2); and
where the relative position of the inner tube (1) and the outer pipe (4) determines the spatial position and length of the bendable telescopic element (2).

2. The bendable telescopic lance of claim 1, wherein the outlet side of the bendable telescopic element (2) comprises an end outlet (231) and the inner tube (1) is connected to the end outlet (231).

3. The bendable telescopic lance of claim 1, wherein the outlet side of the bendable telescopic element (2) comprises a base connector (211) and the outer pipe (3) is connected to the base connector (211).

4. The bendable telescopic lance of claim 1, wherein the bendable telescopic element (2) comprises a telescope base (21) and a telescope end (23) arranged in a telescopic manner.

5. The bendable telescopic lance of claim 1, wherein the bendable telescopic element (2) comprises one or more intermediate elements (22) arranged in a telescopic manner and located between a telescope base (21) and a telescope end (23).

6. The bendable telescopic lance of claim 5, wherein the one or more intermediate elements (22) comprise between 1 and 8 intermediate elements (22).

7. The bendable telescopic lance of claim 5, wherein the components of the telescope base (21) and telescope end (23) and optionally the intermediate elements (22) of the bendable telescopic element (2) are slidably connected to each other using a tab (9) and groove (10) system, wherein the tab (9) of one component engages with the groove (10) of the adjacent component.

8. The bendable telescopic lance of claim 1 further comprising a handle (5) with an inside and an outside; wherein the inside of the handle (5) is fixedly attached to the outside of the outer pipe (4).

9. The bendable telescopic lance of claim 8, wherein the handle (5) further comprises a locking mechanism arranged such that the spatial position between the inner tube (1) and the outer tube (4) is fixed when engaged.

10. The bendable telescopic lance of claim 1, wherein the bendable telescopic lance (8) is used with a high pressure sprayer.

11. The bendable telescopic lance of claim 1, wherein the bendable telescopic lance is adapted for the spraying of material chosen from the group consisting of: particulate matter, liquids, gases, sand, paint, aqueous solutions, water, air, and steam.

12. The bendable telescopic lance of claim 2, wherein the inner tube (1) comprises one or more flexible tube end sections (11) and one or more tube body sections (12); wherein the flexible tube sections (11) are connected to form a continuous tube; the tube body sections (12) are connected to form a continuous tube; and where the outlet end of the flexible tube section (11) is connected to the end outlet (231).

13. A method for adjusting the spraying direction of a material of a bendable telescopic lance, the lance comprising:
a flexible inner tube (1), a bendable telescopic element (2) with an inlet side and an outlet, and an outer pipe (4); wherein
the flexible inner tube (1) is located inside, and connected in a longitudinally mutually slidable manner to, the outer pipe (4);
the outer pipe (4) is connected to the inlet side of the bendable telescopic element (2) and the inner tube (1) is connected to the outlet side of the bendable telescopic element (2);
wherein the bendable telescopic element (2) comprises a telescope base (21) on the inlet side and a telescope end (23) on the outlet side arranged to fit together in a telescopic manner and; wherein
the method comprises the steps of:
a. moving the outer pipe (4) with respect to the inner tube (1); and
b. changing the length of the bendable telescopic end element (2) by telescopically changing the distance between the telescope base (21) and the telescope end (23) to change the relative position of the inner tube (1) with regard to the outer pipe (4); and thereby
c. changing the spraying direction on the outlet side of the bendable telescopic end element (2).
